(19) United States
(12) Patent Application Publication
(10) Pub. No.: US 2014/0344350 A1
(43) Pub. Date: Nov. 20, 2014

(54) Image Session Invitation and Management Techniques

(71) Applicant: Adobe Systems Incorporated, San Jose, CA (US)

(72) Inventors: Richard P. Sinn, Milpitas, CA (US); Allan M. Young, Santa Rosa, CA (US)

(73) Assignee: Adobe Systems Incorporated, San Jose, CA (US)

(21) Appl. No.: 13/895,227

(22) Filed: May 15, 2013

(51) Int. Cl. H04L 29/06

(52) U.S. Cl. CPC H04L 65/403
USPC 709/204

(57) ABSTRACT

Image session invitation and management techniques are described. In one or more implementations, an invitation to join an image sharing session as a potential member is broadcast, e.g., over a local wireless area network by a computing device. An indication of acceptance is received from the potential member at the computing device, the indication including an identity of the potential member. A communication is formed by the computing device for communication via a network to a service provider that is configured to manage the image sharing session. The communication includes the identity of the potential member and an identity of the image sharing session. The communication is also configured to cause the service provider to add the potential member to the image sharing session to share images with other members of the image sharing session or receive images that are shared by the other members of the image sharing session.

### BACKGROUND

The prevalence of image capture devices is ever increasing. This may be due in part to inclusion of cameras in mobile communication devices such as mobile phones, tablets, and so on. Because of this, users may be able to capture images at a variety of different locations as desired.

For example, a user may view and/or participate in an event, such as a sports event, concert, social event (e.g., wedding, birthday), and so on. Because the event may have quite a few attendees, there may be a good likelihood of images being captured by a large portion of the attendees due to the prevalence of image capture devices. However, conventional techniques that were utilized to share images could be involved, limited to attendees “known” to the user, and so on. Thus, even though images may be captured by a variety of different attendees it may be difficult to share these images between the attendees using conventional techniques.

### SUMMARY

Image session invitation and management techniques are described. In one or more implementations, an invitation to join an image sharing session as a potential member is broadcast, this may be performed over a local wireless area network by a computing device. An indication of acceptance is received from the potential member at the computing device, the indication including an identity of the potential member. A communication is formed by the computing device for communication via a network to a service provider that is configured to manage the image sharing session. The communication includes the identity of the potential member and an identity of the image sharing session. The communication is also configured to cause the service provider to add the potential member to the image sharing session to share images with other members of the image sharing session or receive images that are shared by the other members of the image sharing session.

In one or more implementations, an image is captured by a computing device of a representation displayed on a display device of another computing device. A communication is formed by the computing device for communication via a network to a service provider that is configured to manage an image sharing session. The communication includes the data of the representation that is usable to cause a potential member to be added to an image sharing session to share images with other members of the image sharing session or receive images that are shared by the other members of the image sharing session.

In one or more implementations, a system includes one or more computing devices having one or more modules implemented at least partially in hardware, the one or more modules configured to perform operations. The operations include receiving a communication including an image of representation captured by an image capture module of a computing device, the representation displayed on a display device of another computing device. The representation is used to add a member to an image sharing session and the image sharing session is managed to support sharing of images between members of the image sharing session.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein relating to image session invitations and management thereof.

FIG. 2 depicts a system in an example implementation that employs a proximity invitation technique to invite potential members to join an image sharing session using a broadcast.

FIG. 3 depicts an example system that employs a proximity invitation technique to invite potential members to join an image sharing session using a scanning technique.

FIG. 4 depicts an example system that employs a proximity invitation technique to invite potential members to join an image sharing session using another scanning technique.

FIG. 5 is a flow diagram depicting a procedure in an example implementation in which a proximity invitation technique involving a broadcast is utilized to invite potential members to participate in an image sharing session.

FIG. 6 is a flow diagram depicting a procedure in an example implementation in which a proximity invitation technique involving is utilized to invite potential members to participate in an image sharing session.

FIG. 7 is a flow diagram depicting a procedure in an example implementation in which an image sharing session is managed by a service provider.

FIG. 8 illustrates an example system including various components of an example device that can be implemented as any type of computing device as described and/or utilize with reference to FIGS. 1-7 to implement embodiments of the techniques described herein.

### DETAILED DESCRIPTION

Overview

The increasing prevalence of image capture devices (e.g., cameras on mobile phones) has resulted in a corresponding increase in the amount of images captured even by an average user. Further, this prevalence has also increased the likelihood that relatively large proportions of attendees at an event not only have access to an image capture device but actively use the device as part of their interaction with the event. However, conventional techniques that were utilized to share images often involved manual communication of the images and were often limited to “known” users, such as friends of a user.

Image session invitation and management techniques are described. In one or more implementations, techniques are described to add potential members to an image sharing session that may be maintained “over the cloud” by a service provider. For example, a broadcast technique may be employed in which an invitation is broadcast by a creator of an image sharing session over a local wireless area network, such as a network configured according to Bluetooth, Wi-Fi, or other wireless standards. Thus, in this example a mobile phone of the creator of the image sharing session may broadcast the invitation locally to other attendees of an event without “knowing” the other attendees.

The other attendees that are interested in becoming members of the image sharing session may respond with an identification of the attendee. This identification may be verified by the creator of the session and if so verified, the identification and an identifier of the image sharing session may then be communicated to a service provider that manages the image sharing session. In this way, wireless functionality of a mobile communications device (e.g., the mobile phone) may be used to broadcast invitations to potential members without a user being aware of the identities of the potential members.

In another example, a scanning technique may be utilized to add potential members to an image sharing session. This may be performed in a variety of ways. A creator of an image sharing session, for instance, may scan a representation that is usable to identify a potential member of the image sharing session, such as a quick response (QR) code displayed on the potential member's phone. Data associated with the representation (e.g., the representation itself, a result of processing the representation, etc.) may then be communicated to a service provider to add that potential member to the image sharing session. Thus, in this example permission to add the potential member is implicit in the sending of the identification by the creator of the session, although other examples are also contemplated.

In a further example, a potential member may wish to join an image sharing session and therefore scan a representation usable to identify the image sharing session, such as a QR code displayed on a mobile phone of a creator of the image sharing session, on a poster associated with an event, and so on. Data associated with the representation along with an identification of the potential member (i.e., a user that scanned the representation) may then be communicated to a service provider as before. Thus, in this instance permission to join is also implicit through scanning of the session representation as output by a creator's mobile device. Verification techniques may also be employed, such as in the “poster” example to add members to an image sharing session. A variety of other examples are also contemplated, further discussion of which may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

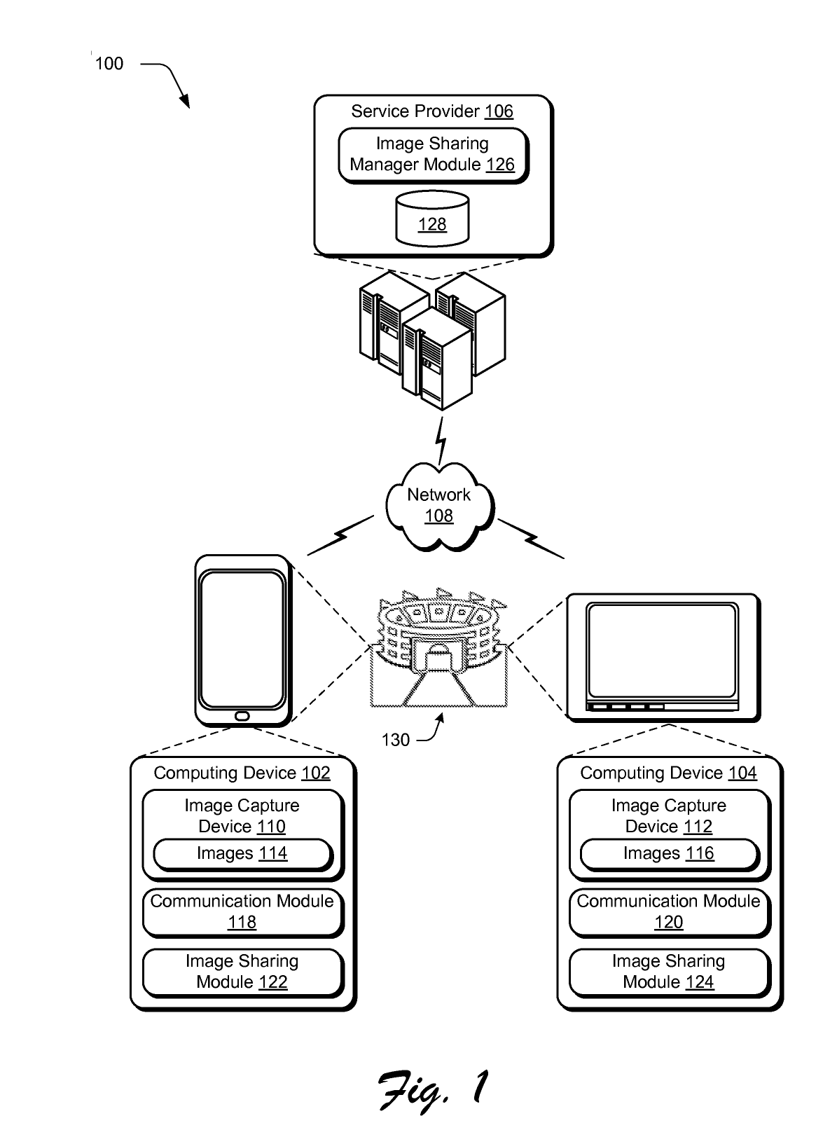

FIG. 1 is an illustration of an environment 100 in an example implementation that is operable to employ techniques described herein. The illustrated environment 100 includes computing devices 102, 104 and a service provider 106 that are communicatively coupled via a network 108. The computing devices 102, 104 may be configured in a variety of ways.

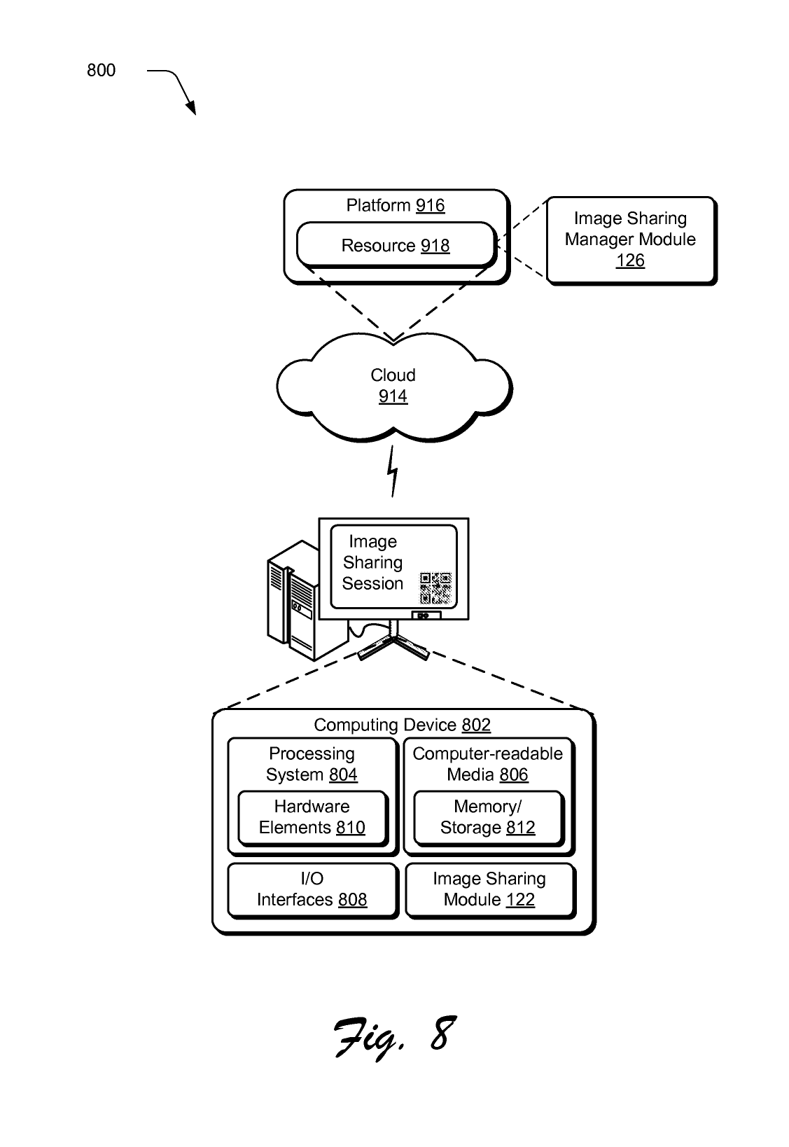

The computing devices 102, 104 for instance, may be configured as desktop computers, laptop computers, a mobile device (e.g., assuming a handheld configuration such as a tablet or mobile phone), and so forth. Thus, the computing devices 102, 104 may range from full resource devices with substantial memory and processor resources (e.g., personal computers, game consoles) to a low-resource device with limited memory and/or processing resources (e.g., mobile devices, a dedicated camera, video recorder, and so on). Additionally, each of the computing devices 102, 104 may be representative of a plurality of different devices, such as multiple servers utilized by a business to perform operations “over the cloud” as shown as implementing the service provider 106 and as further described in relation to FIG. 8.

Each of the computing devices 102, 104 is illustrated as including a respective image capture device 110, 112. The images capture devices 110, 112 are representative of software and hardware functionality to capture images 114, 116, respectively. As such, the image capture devices 110, 112 may be configured in a variety of ways to capture images, such as through use of a charge coupled device (CCD) and so on.

The computing devices 102, 104 are also illustrated as including respective communication modules 118, 120. The communication modules 118, 120 are representative of functionality to communicate via the network 108. For example, the communication modules 118, 120 may include software and hardware to support a wired network connection, such as with a wired Ethernet, modem to a plain old telephone system (POTS), cable connection, digital subscriber line (DSL), and so on.

The communication modules 118, 120 may also include functionality to communicate with the network 108 wirelessly. This may include support of short to mid-range communication, which may include near (e.g., IEEE 802.15.1 standards also known as “Bluetooth”) and midrange (e.g., IEEE 802.11 standards also known as “Wi-Fi”) wireless communications over a wireless local area network. This may also include use for relatively far distances over a wireless wide area network, including IEEE 802.16 which is also known as “WiMAX,” cellular technologies (e.g., 3G, 4G, LTE), and so on.

As previously described, one of the most difficult problems in group photography is to gather people in the group to take pictures together in an event. Conventional techniques involved inviting people via email or via a social network to share images. However, invitations sent this way often created obstacles for invitees, which could hinder a user's desire to participate in sharing images.

Accordingly, image session invitation and management techniques may be employed by the environment 100. As illustrated, the computing devices 102, 104 include respective image sharing modules 122, 124 and the service provider 106 includes an image sharing manager module 126 and storage 128. These modules are representative of functionality to create and manage membership of an image sharing session. For example, a user of computing device 102 may attend an event 130, such as a sporting event as illustrated, a social event (e.g., birthday, wedding), concert, speech, and so on. The image sharing module 122 may provide an option to create an image sharing session for association with the event through communication with the image sharing manger module 126 via the network 106.

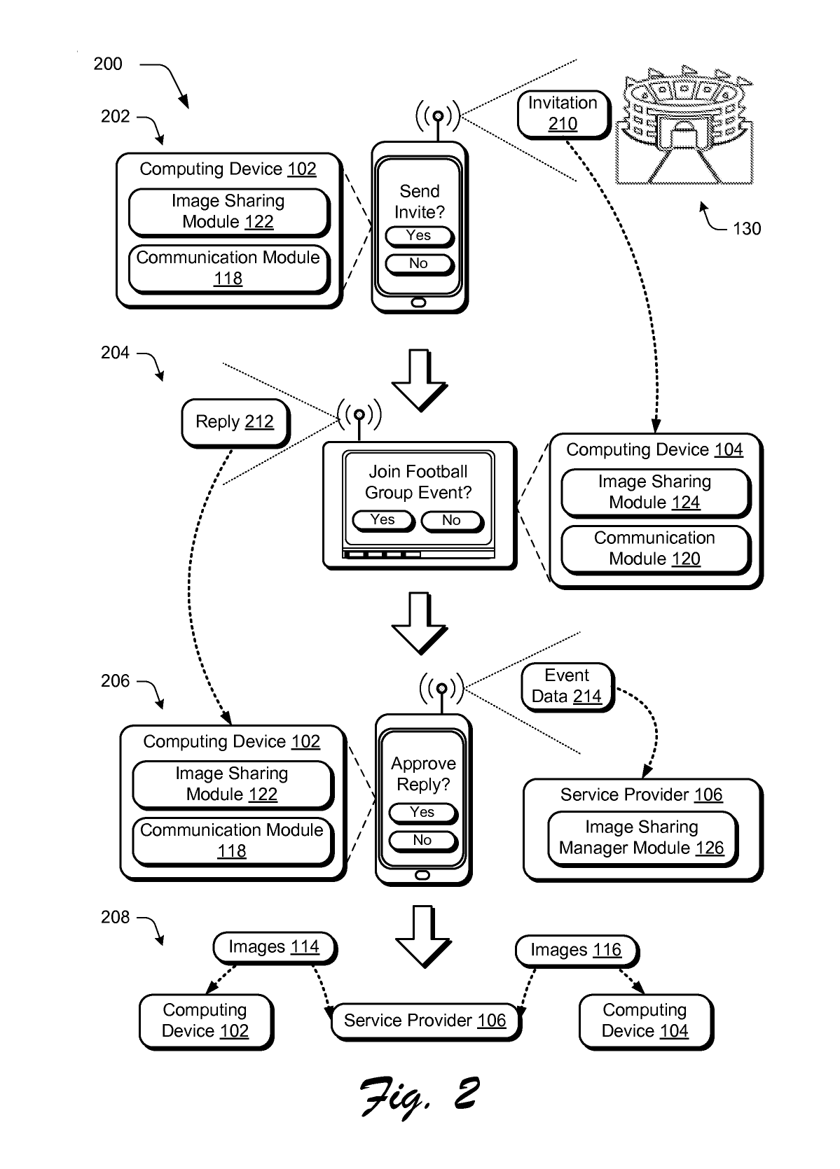

The user may then utilize the image sharing module 122 and computing device 102 to invite other attendees of the event 130 to join the image sharing session. This may be performed in a variety of ways, such as to employ a proximity invitation system 130 to add potential members to the image sharing session. For example, the computing device 102 may leverage a local wireless area network to broadcast an invitation to another computing device 104 located at the event 130. The invitation may then be used to join the image sharing session through interaction with the image sharing module 124, further discussion of which may be found in relation to FIG. 2.

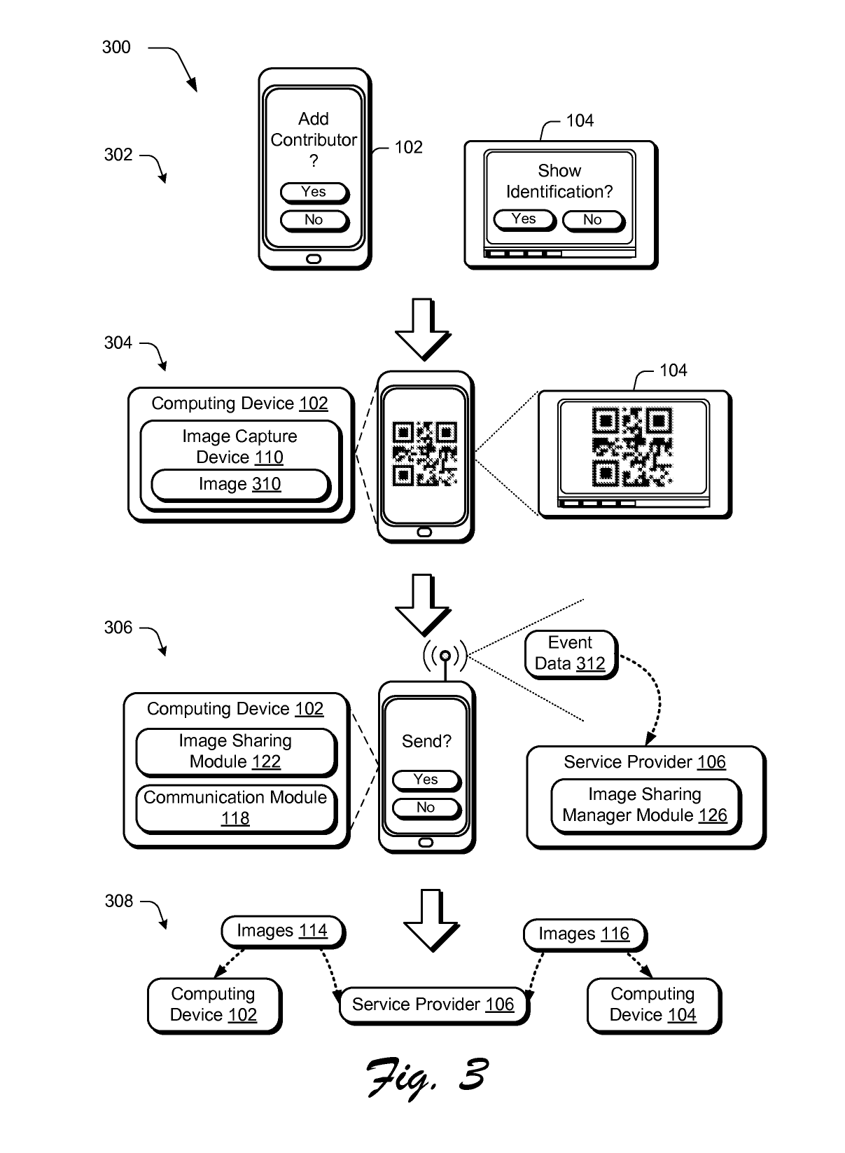

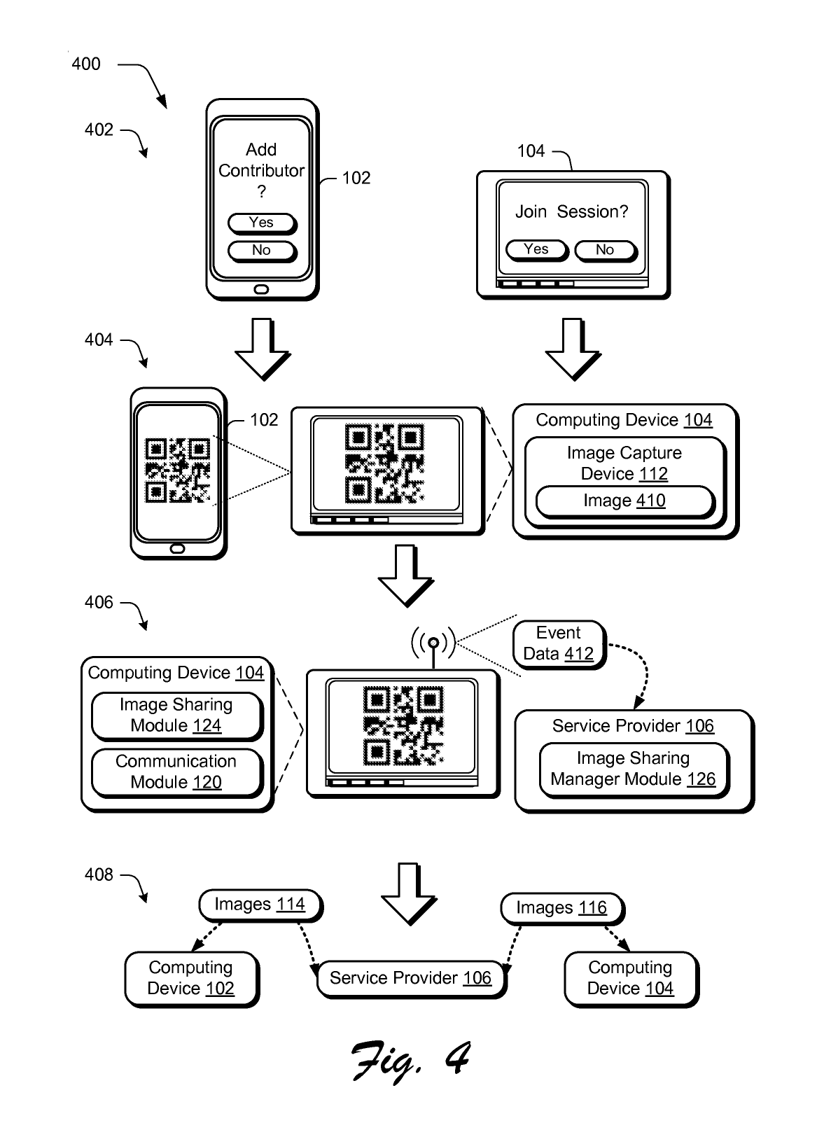

In another example, a scanning technique may be utilized. Computing device 104, for instance, may display a representation usable to identify a user associated with the computing device 104, e.g., a user account. A user of computing device 102 may then capture an image of this representation and use it to join the user to the image sharing session as further described in relation to FIG. 3. In another instance, a user of computing device 102 that caused the image sharing session to be created may display a representation that identifies the image sharing session. A user of computing device 104 may then capture an image of this representation and use it to join the image sharing session as further described in relation to FIG. 4.

Regardless of the proximity invitation technique used, the image sharing session may be managed by the image sharing manager module 126 to share images. This may include support of sharing of images from storage 128, support of direct communication between the computing devices 102, 104 without communication through the service provider 106, and so on. Further discussion of these and other techniques may be found in the following examples.

FIG. 2 depicts an example system 200 that employs a proximity invitation technique to invite potential members to join an image sharing session using a broadcast. The system 200 is shown using first, second, third, and fourth stages 202, 204, 206, 208. A user may obtain the image sharing module 122 in a variety of ways, such as via an application downloaded from the service provider 106, via an application store maintained by another service provider (e.g., where the image sharing module 122 is available for a fee, is free in return for viewing advertisements), and so on.

The user may then use the image sharing module 112 to interact with the image sharing manager module 126 of the service provider 106 to create an image sharing session. This may include creation of a unique identifier for the image sharing session and metadata describing the session, e.g., a name of an associated event 130, location, and so on. This data may then be communicated from the service provider 106 to the computing device 102 that is associated with a user that created the image sharing session, e.g., is accessing a user's account of the service provider 106.

At the first stage 202, the computing device 102 utilizes an image sharing module 112 and communication module 118 to broadcast an invitation 210 over a wireless local network at an event 130. The image sharing module 122, for instance, may output a user interface that includes an option to send an invitation 210. In response to selection of the invitation 210, the image sharing module 122 may cause the invitation 210 to be broadcast using wireless local area network functionality of the communication module. As previously described, this may include Bluetooth, Wi-Fi, and other functionality to wirelessly broadcast the invitation 210 within near and midrange distances from the computing device 102, e.g., within twenty meters or so. In this way, the broadcast of the invitation may be made available to other users that are likely attending the event 130.

At the second stage 204, the invitation 210 is received by another computing device, such as computing device 104 that is configured as a tablet in this example. An image sharing module 124 may be employed by the computing device 104 to recognize the invitation 210 and display an option in a user interface to form a request to join the image sharing session. The user interface, for instance, may include metadata used to describe the event by a creator of the image sharing session, data that describes the creator of the image sharing session, data that identifies the image sharing session itself (e.g., number of members, identification of other members), and so on.

For example, a user associated with the computing device 104 may travel to the event 130 of FIG. 1 and wish to participate in one or more image sharing sessions that are available at the event 130. Therefore, a user may “bring up” the image sharing module 124 to receive invitations 210 broadcast at the event 130 and respond to invitations of interest by accepting the invitation 210. In response, the image sharing module 124 may form a communication to reply 212 to the invitation 210, which may include an identifier of a user of the computing device 104, e.g., the user's account at the service provider 106, a “guest” identifier that does not uniquely identify the user, an identifier of the device itself, and so on.

At the third stage 206, the computing device 102 that sent the invitation 210 at the first stage 202 receives the reply 212 from the computing device 104 to join the image sharing session. In response, the image sharing module 122 may then output a user interface having an option that is configured to verify whether to permit the potential member to join the image sharing session. The user interface, for instance, may include the unique identifier of the user (e.g., a name of a user account) and other identifying data, such as an image from a social network account and so on as desired by the sending user.

If the reply 212 is approved by the user of the computing device 102, the image sharing module 122 may then form a communication for communication via the network 108 to the service provider 106 to join the potential member to the image sharing session. For example, the communication may include event data 214 that uniquely identifies the image sharing session as described above as well as an identifier of a user received in the reply 212. The image sharing manager module 126 may then use the event data 214 to add the user associated with the computing device 104 to the identified image sharing session.

At the fourth stage 208, the service provider 106 manages sharing of images 114, 116 between the computing devices 102, 104 as part of the image sharing session. For example, the image sharing module 126 of the service provider 106 may output a user interface via which users of the computing devices 102, 104 may select which images to download, upload, and so on. In this way, the images 114, 116 may be shared between the computing devices 102, 104 as part of the image sharing session. Thus, in this example the proximity invitation technique may support ease of detection of broadcasted image sharing session and support approval and rejection of these sessions. Additionally, through use of standardized wireless local area network communications, cross platform compatibility may be supported, although other examples are also contemplated.

Further, although a single invitation example was described in relation to FIG. 2 it should be readily apparent that multiple image sharing sessions may be supported concurrently, such as to share a single image with multiple image sharing sessions, e.g., by selecting an image and then selecting identifiers of particular ones of the image sharing sessions. Another example of a proximity invitation system is described as follows and shown in a corresponding figure.

FIG. 3 depicts an example system 300 that employs a proximity invitation technique to invite potential members to join an image sharing session using a scanning technique. The system 300 is also shown using first, second, third, and fourth stages 302, 304, 306, 308. As before, the computing devices 102, 104 may obtain the image sharing modules in a variety of ways.

At the first stage 302, users of the computing devices 102, 104 may wish to participate in an image sharing session, which in this instance is also created by a user of the computing device 102. Thus, a user interface may be displayed by the computing device 102 that givens an option to add a member to an image sharing session. A user interface displayed by the computing device 104, however, may provide an option to show identification that is usable to add the user to an image sharing session.

At the second stage 304, responsive to selection of the option to show identification, the computing device 104 displays a representation that is usable to identify the user, which in this instance in a quick response (QR) code. The representation, for instance, may identify a user's account maintained at the service provider 106 or include other identifying information.

The computing device 102 may then employ an image capture device 110 to capture an image 310 of the display of the representation by the other computing device 104. In other words, the image 310 may be scanned by “taking a picture” of the other computing device 104 that shows the representation.

At the third stage 306, the image sharing module forms a communication for communication to the service provider 106. The communication may include data from the representation, such as the image 310 of the representation, information obtained by processing the image of the representation (i.e., to identify “what” is represented by the representation), and so on. A communication module 118 may then communicate this information as event data 312 via the network 108 of FIG. 1, which although wireless communication is illustrated is should be readily apparent that wired techniques are also contemplated. The event data 312, for instance, may also include an identifier of the image sharing session that is usable by the service provider 106 to add the potential member as a member to the image sharing session.

Further, in this example implicit permission techniques may be employed such that verification is not utilized. For example, by capturing the image 310 by a creator of the image sharing session and sending that information to include a user associated with the representation to the image sharing session it may be implied that the creator of the session wants to add the user. Other examples are also contemplated in which verification is performed by the service provider 106 before permitting the user to join as a member of the image sharing session.

At the fourth stage 308, the service provider 106 manages sharing of images 114, 116 between the computing devices 102, 104 as part of the image sharing session. As before, the images 114, 116 may be shared between the computing devices 102, 104 as part of the image sharing session. Thus, in this example the proximity invitation technique may support a reliable invitation system that leverages visual recognition technologies and supports “one-on-one” selectivity that may be leveraged as an implicit verification. Although this example described scanning usable to identify a user to be added to an image sharing session, scanning techniques may also be employed in a variety of other ways, an example of which is described as follows and shown in a corresponding figure.

FIG. 4 depicts an example system 400 that employs a proximity invitation technique to invite potential members to join an image sharing session using another scanning technique. The system 400 is also shown using first, second, third, and fourth stages 402, 404, 406, 408. As before, the computing devices 102, 104 may obtain the image sharing modules in a variety of ways.

At the first stage 402, users of the computing devices 102, 104 may wish to participate in an image sharing event, which in this instance is also created by a user of the computing device 102. Thus, a user interface may be displayed by the computing device 102 that givens an option to add a member to an image sharing session. A user interface displayed by the computing device 104, however, may provide an option that is selectable to join an image sharing session.

At the second stage 404, responsive to selection of the option to add a contributor, the computing device 102 displays a representation that is usable to identify the image sharing session, which in this instance in a quick response (QR) code. The representation, for instance, may include data received from the service provider 106 responsive to creating the image sharing session that is usable to uniquely identify the session by the image sharing manager module 126.

The computing device 104 may then employ an image capture device 112 to capture an image 410 of the display of the representation by the computing device 102. Thus, the image 310 may be scanned by “taking a picture” of the other computing device 102 that shows the representation on the display device.

At the third stage 406, the image sharing module 124 forms a communication for communication to the service provider 106. The communication may include data from the representation, such as the image 410 of the representation, information obtained by processing the image of the representation (i.e., to identify “what” image sharing session is represented by the representation), and so on. A communication module 120 may then communicate this information as event data 412 via the network 108 of FIG. 1, which although wireless communication is illustrated is should be readily apparent that wired techniques are also contemplated. The event data 412, for instance, may also include an identifier of the image sharing session that is usable by the service provider 106 to add the potential member as a member to the image sharing session.

Like above, in this example implicit permission techniques may be employed such that verification is not utilized. For example, by capturing the image 410 output by a creator of the image sharing session it may be implied that the creator of the session wants to add the user. Other examples are also contemplated in which verification is performed by the service provider 106 before permitting the user to join as a member of the image sharing session. For instance, the representation may be displayed as part of an event poster and thus verification may be used to confirm whether a user is to be permitted to contribute and/or view images that are part of the image sharing session.

At the fourth stage 408, the service provider 106 manages sharing of images 114, 116 between the computing devices 102, 104 as part of the image sharing session. As before, the images 114, 116 may be shared between the computing devices 102, 104 as part of the image sharing session. Thus, in the proximity invitation technique may also support a reliable invitation system that leverages visual recognition technologies and supports “one-on-one” selectivity that may be leveraged as an implicit verification.

Example Procedures

The following discussion describes image sharing and invitation techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-4.

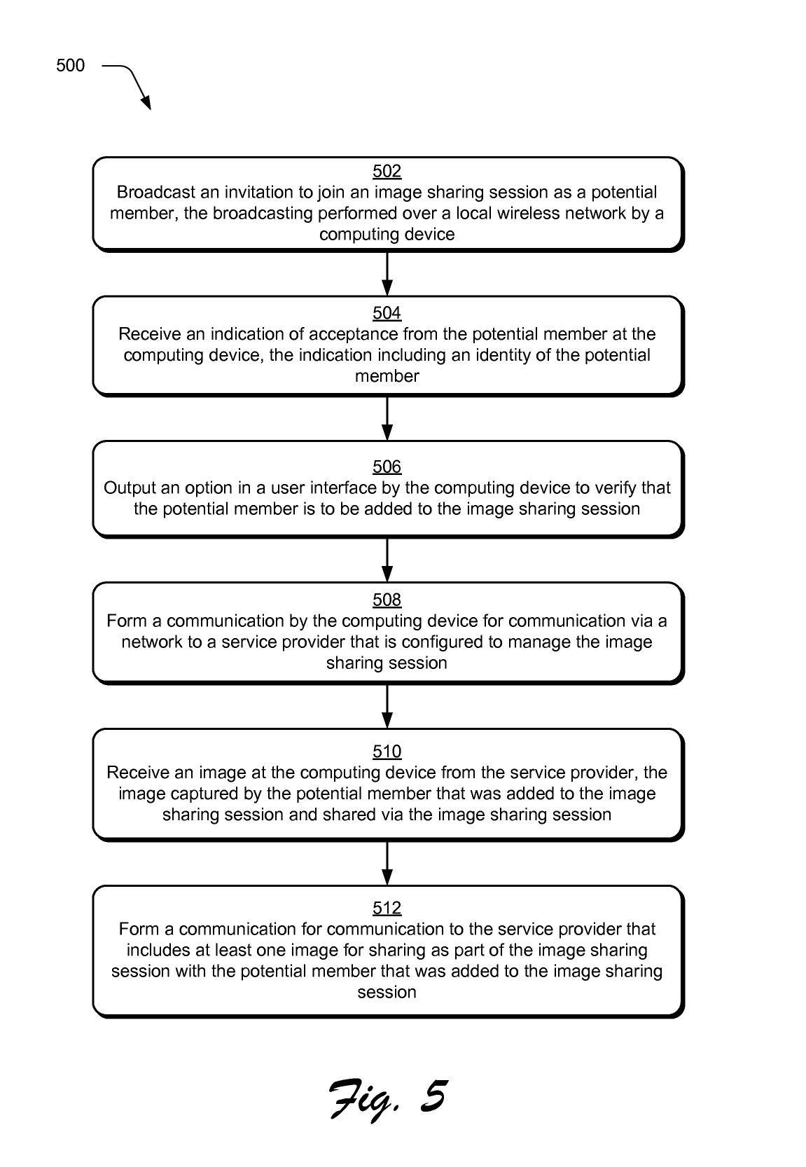

FIG. 5 depicts a procedure 500 in an example implementation in which a proximity invitation technique involving a broadcast is utilized to invite potential members to participate in an image sharing session. An invitation to join an image sharing session as a potential member is broadcast, e.g., over a local wireless area network by a computing device (block 502). For example, the invitation may be broadcast over a wireless Bluetooth, Wi-Fi, or other network over a range of approximately 20 meters. As described above, the invitation may include an identifier of the image sharing session and other metadata usable to describe the image sharing session.

An indication of acceptance is received from the potential member at the computing device, the indication including an identity of the potential member (block 504). The indication, for example, may include an identifier of a user's account associated with the service provider 106, an email address, social network identification, and so on.

An option is output in the user interface to verify that the potential member is to be added to the image sharing session (block 506). A user of computing device 102, for instance, may view the option in a user interface that identifies a user associated with the computing device 104 used to form the acceptance of the invitation. The user of computing device 102 may then verify whether to add the other user or not by interacting with the user interface.

A communication is formed by the computing device for communication via a network to a service provider that is configured to manage the image sharing session (block 508). The communication may include the identity of the potential member and an identity of the image sharing session. The communication may also be configured to cause the service provider to add the potential member to the image sharing session to share images with other members of the image sharing session or receive images that are shared by the other members of the image sharing session.

For example, an image may be received at the computing device from the service provider, the image captured by the potential member that was added to the image sharing session and shared via the image sharing session (block 510). Computing device 102, for instance, may receive images 116 captured by computing device 104 from the service provider 106 via the image sharing session.

In another example, a communication is formed for communication to the service provider that includes at least one image for sharing as part of the image sharing session with the potential member that was added to the image sharing session (block 512). A computing device 102, for instance, may capture images 114 for sharing via the service provider 106 with the other computing device 104. A variety of other examples are also contemplated.

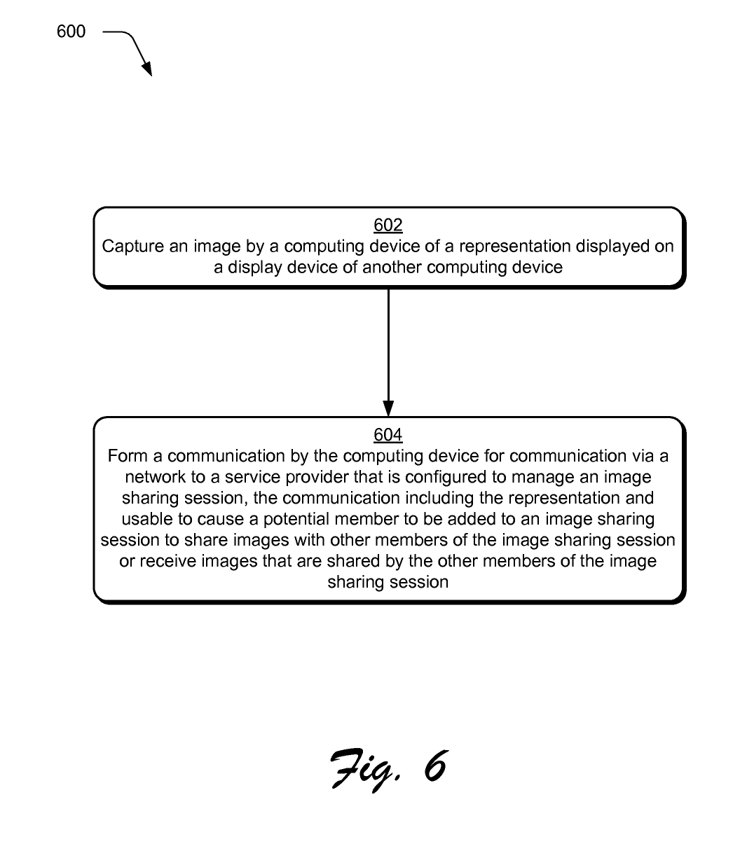

FIG. 6 depicts a procedure 600 in an example implementation in which a proximity invitation technique involving scanning a representation of a user is utilized to invite potential members to participate in an image sharing session. An image is captured by a computing device of a representation displayed on a display device of another computing device (block 602). As shown in FIG. 3, for instance, computing device 102 may utilize an image capture device 110 to capture an image of a QR code or other representation displayed by computing device 104 that identifies a particular user. As shown in FIG. 4, computing device 104 may utilize an image capture device 112 to capture an image of a QR code or other representation displayed by computing device 102 that identifies a particular image sharing session.

A communication is formed by the computing device for communication via a network to a service provider that is configured to manage an image sharing session, the communication including data associated with the representation and usable to cause a potential member to be added to an image sharing session to share images with other members of the image sharing session or receive images that are shared by the other members of the image sharing session (block 604). For instance, data associated with the representation that identifies the user (e.g., the representation itself, information represented by the representation, and so on) may be used to add the user to the image sharing session as described in FIG. 3. In another instance, For instance, data associated with the representation that identifies the image sharing session may be used to add the user to the image sharing session as described in FIG. 4. Other examples of scanning techniques are also contemplated as further described above.

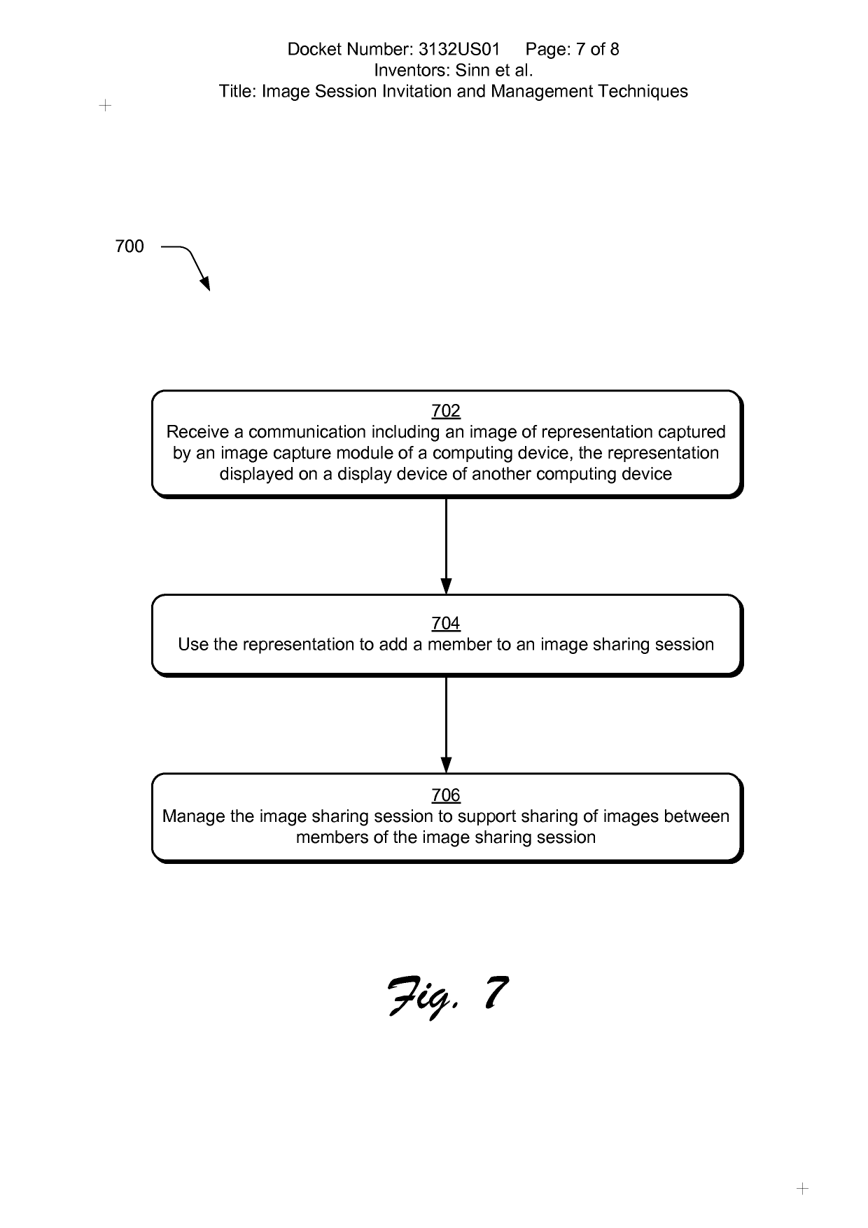

FIG. 7 depicts a procedure 700 in an example implementation in which an image sharing session is managed by a service provider. A communication is received that includes an image of a representation captured by an image capture module of a computing device, the representation display on a display device of another computing device (block 702). For example, the representation may identify a particular user as described in relation to FIG. 3, the representation may identify a particular image sharing session as described in relation the FIG. 4, and so on.

The representation is used to add a member to an image sharing session (block 704). The image sharing manager module 126, for instance, may use the identification of a user sent from a creator of the image sharing session to add the identified user to an image sharing session. In another example, an identification of the image sharing session may be sent to add a user sending the identification to the image sharing session.

The image sharing session is managed to support sharing of images between members of the image sharing session (block 706). This may include support of uploading of images for viewing by other members as well as downloading images captured by other members. Thus, the service provider 106 may support functionality “over the cloud” to implement and manage an image sharing session.

Example System and Device

FIG. 8 illustrates an example system generally at 800 that includes an example computing device 802 that is representative of one or more computing systems and/or devices that may implement the various techniques described herein. This is illustrated through inclusion of the image sharing module 122 and image sharing manager module 126. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

The techniques described herein may be supported by various configurations of the computing device 802 and are not limited to the specific examples of the techniques described herein. This functionality may also be implemented all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 may include applications and/or data that can be utilized while computer processing is executed on servers that are remote from the computing device 802. Resources 818 can also include services provided over the Internet and/or through a subscriber network, such as a cellular or Wi-Fi network.

The platform 816 may abstract resources and functions to connect the computing device 802 with other computing devices. The platform 816 may also serve to abstract scaling of resources to provide a corresponding level of scale to encountered demand for the resources 818 that are implemented via the platform 816. Accordingly, in an interconnected device embodiment, implementation of functionality described herein may be distributed throughout the system 800. For example, the functionality may be implemented in part on the computing device 802 as well as via the platform 816 that abstracts the functionality of the cloud 814.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
broadcasting an invitation to join an image sharing session as a potential member, the broadcasting performed over a local wireless area network by a computing device;
receiving an indication of acceptance from the potential member at the computing device, the indication including an identity of the potential member; and
forming a communication by the computing device for communication via a network to a service provider that is configured to manage the image sharing session, the communication:
including the identity of the potential member and an identity of the image sharing session; and
configured to cause the service provider to add the potential member to the image sharing session to share images with other members of the image sharing session or receive images that are shared by the other members of the image sharing session.

2. A method as described in claim 1, wherein the image sharing session is associated with an event.

3. A method as described in claim 1, wherein local wireless area network is configured according to one or more Institute of Electrical and Electronics Engineers (IEEE) 802.15.1 or 802.11 standards.

4. A method as described in claim 3, wherein a range of the local communication is approximately twenty meters or less.

5. A method as described in claim 1, further comprising outputting an option in a user interface by the computing device to verify that the potential member is to be added to the image sharing session and wherein the forming is performed responsive to receipt of verification that the potential member is to be added as a member to the image sharing session.

6. A method as described in claim 1, further comprising receiving an image at the computing device from the service provider, the image captured by the potential member that was added to the image sharing session and shared via the image sharing session.

7. A method as described in claim 1, further comprising forming a communication for communication to the service provider that includes at least one image for sharing as part of the image sharing session with the potential member that was added to the image sharing session.

8. A method comprising:
capturing an image by a computing device of a representation displayed on a display device of another computing device; and
forming a communication by the computing device for communication via a network to a service provider that is configured to manage an image sharing session, the communication including data associated with the representation and usable to cause a potential member to be added to an image sharing session to share images with other members of the image sharing session or receive images that are shared by the other members of the image sharing session.

9. A method as described in claim 8, wherein the data associated with representation is usable by the service provider to uniquely identify a user associated with the other computing device.

10. A method as described in claim 9, wherein the computing device that performs the capturing and the forming is associated with a creator of the image sharing session.

11. A method as described in claim 8, wherein the data associated with representation is usable by the service provider to uniquely identify the image sharing session.

12. A method as described in claim 11, wherein the computing device that performs the capturing and the forming is associated with the potential member of the image sharing session.

13. A method as described in claim 8, wherein the representation is a quick response (QR) code.

14. A method as described in claim 8, wherein the computing device is a mobile phone or tablet.

15. A system comprising:
one or more computing devices having one or more modules implemented at least partially in hardware, the one or more modules configured to perform operations comprising:
receiving a communication including data associated with an image of representation captured by an image capture module of a computing device, the representation displayed on a display device of another computing device;
using the data associated with representation to add a member to an image sharing session; and
managing the image sharing session to support sharing of images between members of the image sharing session.

16. A system as described in claim 15, wherein the data associated with representation uniquely identifies a user associated with the other computing device.

17. A system as described in claim 16, wherein the computing device that captured the image is associated with a creator of the image sharing session.

18. A system as described in claim 15, wherein the data associated with representation is usable to uniquely identify the image sharing session.

19. A system as described in claim 18, wherein the computing device that performs the capturing and the forming is associated with the potential member of the image sharing session.

20. A system as described in claim 15, wherein the representation is a quick response (QR) code.
